(19) United States
(12) Patent Application Publication
(10) Pub. No.: US 2010/0066750 A1
(43) Pub. Date: Mar. 18, 2010

(54) MOBILE VIRTUAL AND AUGMENTED REALITY SYSTEM

(75) Inventors: Han Yu, Carpentersville, IL (US); Eric R. Buhrke, Clarendon Hills, IL (US); Julius S. Gyorfi, Vernon Hills, IL (US); Juan M. Lopez, Chicago, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/211,417

(22) Filed: Sep. 16, 2008

(51) Int. Cl. G09G 5/00

(52) U.S. Cl. 345/581

(57) ABSTRACT

A user can create “virtual graffiti” (203)” that will be left for a particular device to view as part of an augmented-reality scene. The virtual graffiti will be assigned to a particular physical location or a part of an object that can be mobile. The virtual graffiti is then uploaded to a network server (101), along with the location and individuals who are able to view the graffiti as part of an augmented-reality scene. When a device that is allowed to view the graffiti is near the location, the graffiti will be downloaded to the device and displayed as part of an augmented-reality scene. To further enhance the user experience, the virtual graffiti can be dynamic, changing based on ambient-light conditions.

### RELATED APPLICATIONS

This application is related to application Ser. No. 11/844538, entitled MOBILE VIRTUAL AND AUGMENTED REALITY SYSTEM, filed Aug. 24, 2007, application Ser. No. 11/858997, entitled MOBILE VIRTUAL AND AUGMENTED REALITY SYSTEM, filed Sep. 21, 2007, to application Ser. No. 11/930974 entitled MOBILE VIRTUAL AND AUGMENTED REALITY SYSTEM, filed Oct. 31, 2007, and to application Ser. No. 11/962139 entitled MOBILE VIRTUAL AND AUGMENTED REALITY SYSTEM, filed Dec. 21, 2007.

### FIELD OF THE INVENTION

The present invention relates generally to messaging, and in particular, to messaging within a mobile virtual and augmented reality system.

### BACKGROUND OF THE INVENTION

Messaging systems have been used for years to let users send messages to each other. Currently, one of the simplest ways to send a message to another individual is to send a text message to the individual's cellular phone. Recently, it has been proposed to expand the capabilities of messaging systems so that users of the network may be given the option of leaving “virtual graffiti” for users of the system. For example, the system described in application Ser. No. 11/844538, entitled MOBILE VIRTUAL AND AUGMENTED REALITY SYSTEM, allows users to post and retrieve various types of virtual content from their mobile devices as the next generation of messaging system to enhance their mobile communication experiences. All virtual content are associated with a physical location, and are superimposed onto the real images captured by phone camera when they are displayed on the screen.

Although the appearance of real objects captured by the camera reflects the lighting conditions of the environment (e.g., they look darker in poor lighting conditions), the virtual objects are rendered using a predetermined illumination that is not related to the real world lighting conditions. Therefore, an effective method of adapting the appearance of virtual objects to various lighting conditions of the real environment is needed for improving the viewing experience for users in a mobile augmented reality messaging system.

### BRIEF DESCRIPTION OF THE DRAWINGS

FIG. 1 is a block diagram of a context-aware messaging system.

FIG. 2 illustrates an augmented-reality scene.

FIG. 3 illustrates an augmented-reality scene.

FIG. 4 is a block diagram of the server of FIG. 1.

FIG. 5 is a block diagram of the user device of FIG. 1.

FIG. 6 is a flow chart showing operation of the server of FIG. 1.

FIG. 7 is a flow chart showing operation of the user device of FIG. 1 when creating graffiti.

FIG. 8 is a flow chart showing operation of the user device of FIG. 1 when displaying graffiti.

FIG. 9 is a flow chart showing operation of the ambient light modification circuitry.

### DETAILED DESCRIPTION OF THE DRAWINGS

In order to address the above-mentioned need, a method and apparatus for messaging within a mobile virtual and augmented reality system is provided herein. During operation a user can create “virtual graffiti” that will be left for a particular device to view as part of an augmented-reality scene. The virtual graffiti will be assigned to either a particular physical location or a part of an object that can be mobile. The virtual graffiti is then uploaded to a network server, along with the location and individuals who are able to view the graffiti as part of an augmented-reality scene.

When a device that is allowed to view the graffiti is near the location, the graffiti will be downloaded to the device and displayed as part of an augmented-reality scene. To further enhance the user experience, the virtual graffiti can be dynamic, changing based on an ambient light source. For example, in an outdoor environment, the context available to the mobile device (time, location, and orientation) can be acquired in order to determine the source and intensity of natural light and apply it to appropriate surfaces of the virtual objects. As the location of a device is already available to GPS-enabled phones, and the locations of the virtual objects are also known to the system, the viewing direction of each virtual object can be calculated in the scene from the device. The direction of sun light, on the other hand, is determined by the current date and time as well as the latitude and longitude of the device. The position of the sun can be determined from solar ephemeris data and used to position a “virtual sun” (i.e., an omni-directional light source) in the virtual coordinate system used by the rendering software. The intensity of sunlight can be adjusted through known attenuation calculations that can further be modified based on current local weather conditions. Simultaneously, a light sensor could be used to determine the ambient light intensity which could also be replicated in the virtual environment to give an even more accurately illuminated scene.

In an augmented reality system, computer generated images, or “virtual images” may be embedded in or merged with the user's view of the real-world environment to enhance the user's interactions with, or perception of the environment. In the present invention, the user's augmented reality system merges any virtual graffiti messages with the user's view of the real world.

As an example, Ed could leave a message for his friends Tom and Joe on a restaurant door suggesting they try the chili. At various times of the day the intensity of the image left would be modified based on how much ambient light was falling on the restaurant door.

The present invention encompasses a method for modifying a virtual graffiti object. The method comprises the steps of obtaining sun location data, obtaining virtual graffiti, and modifying the virtual graffiti based on the sun location data.

The present invention encompasses a method for receiving and displaying virtual graffiti as part of an augmented-reality scene. The method comprises the steps of providing a location, receiving virtual graffiti in response to the step of providing the location, obtaining ambient-light information, modifying the virtual graffiti based on the ambient-light information, and displaying the modified virtual graffiti as part of an augmented-reality scene.

The present invention additionally encompasses an apparatus for receiving and displaying virtual graffiti as part of an augmented-reality scene. The apparatus comprises a transmitter providing a location, a receiver receiving virtual graffiti in response to the step of providing the location, circuitry determining ambient-light information and modifying the virtual graffiti based on the ambient-light information, and an augmented reality system displaying the modified virtual graffiti as part of an augmented-reality scene.

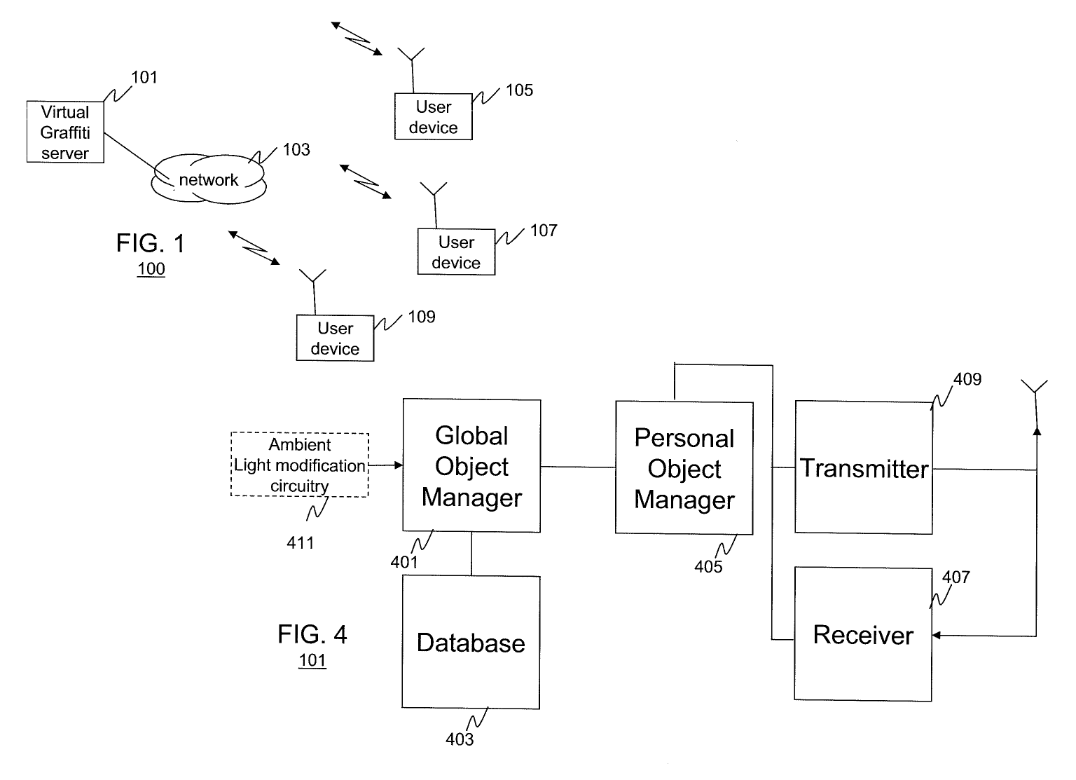

Turning now to the drawings, wherein like numerals designate like components, FIG. 1 is a block diagram of context-aware messaging system 100. System 100 comprises virtual graffiti server 101, network 103, and user devices 105-109. In one embodiment of the present invention, network 103 comprises a next-generation cellular network, capable of high data rates. Such systems include the enhanced Evolved Universal Terrestrial Radio Access (UTRA) or the Evolved Universal Terrestrial Radio Access Network (UTRAN) (also known as EUTRA and EUTRAN) within 3GPP, along with evolutions of communication systems within other technical specification generating organizations (such as ‘Phase 2’ within 3GPP2, and evolutions of IEEE 802.11, 802.16, 802.20, and 802.22). User devices 105-109 comprise devices capable of real-world imaging and providing the user with the real-world image augmented with virtual graffiti.

During operation, a user (e.g., a user operating user device 105) determines that he wishes to send another user virtual graffiti as part of an augmented-reality scene. User device 105 is then utilized to create the virtual graffiti and associate the virtual graffiti with a location. The user also provides device 105 with a list of user(s) (e.g., user 107) that will be allowed to view the virtual graffiti. Device 105 then utilizes network 103 to provide this information to virtual graffiti server 101.

Server 101 periodically monitors the locations of all devices 105-109 along with their identities, and when a particular device is near a location where it is to be provided with virtual graffiti, server 101 utilizes network 103 to provide this information to the device. When a particular device is near a location where virtual graffiti is available for viewing, the device will notify the user, for example, by beeping. The user can then use the device to view the virtual graffiti as part of an augmented-reality scene. Particularly, the virtual graffiti will be embedded in or merged with the user's view of the real-world. It should be noted that in alternate embodiments, no notification is sent to the user. It would then be up to the user to find any virtual graffiti in his environment.

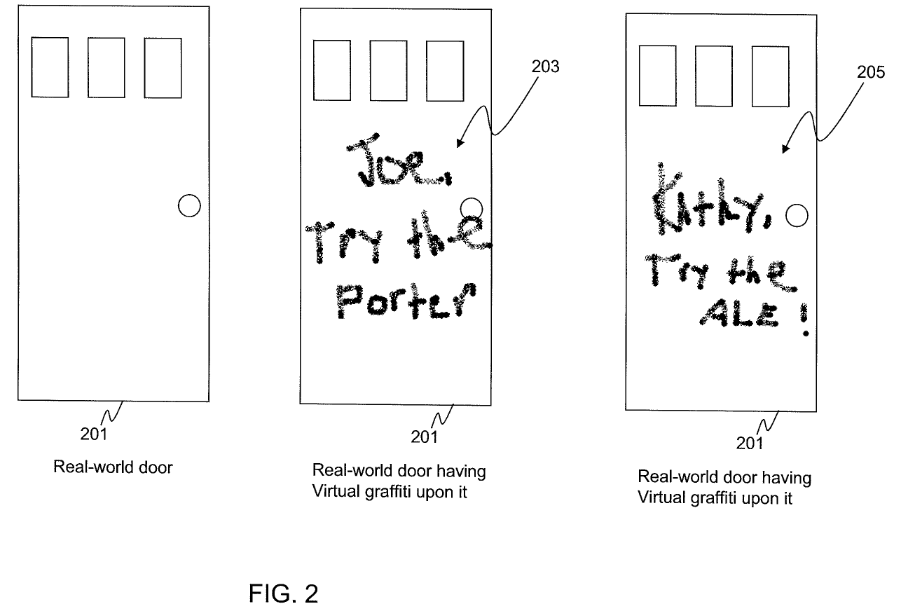

FIG. 2 illustrates an augmented-reality scene. In this example, a user has created virtual graffiti 203 that states, “Joe, try the porter” and has attached this graffiti to the location of a door. As is shown in FIG. 2, the real-world door 201 does not have the graffiti existing upon it. However, if a user has privileges to view the virtual graffiti, then their augmented reality viewing system will show door 201 having graffiti 203 upon it. Thus, the virtual graffiti is not available to all users of system 100. The graffiti is only available to those designated able to view it (preferably by the individual who created the graffiti). Each device 105-109 will provide a unique augmented-reality scene to their user. For example, a first user may view a first augmented-reality scene, while a second user may view a totally different augmented-reality scene (e.g., the user may have left another message 205 for another user). This is illustrated in FIG. 2 with graffiti 205 being different than graffiti 203. Thus, a first user, looking at door 201 may view graffiti 203, while a second user, looking at the same door 201 may view graffiti 205.

Although the above example was given with virtual graffiti 203 displayed on a particular object (i.e., door 201), in alternate embodiments of the present invention, virtual graffiti may be displayed unattached to any object. For example, graffiti may be displayed as floating in the air, or simply in front of a person's field of view. Additionally, although the virtual graffiti of FIG. 2 comprises text, the virtual graffiti may also comprise a “virtual object” such as images, audio and video clips, etc.

As discussed above, to further enhance the user experience, the virtual graffiti can be dynamic, changing based on the ambient light. For example, the shadowing of a virtual object may be allowed to change based on, for example, the position of the sun.

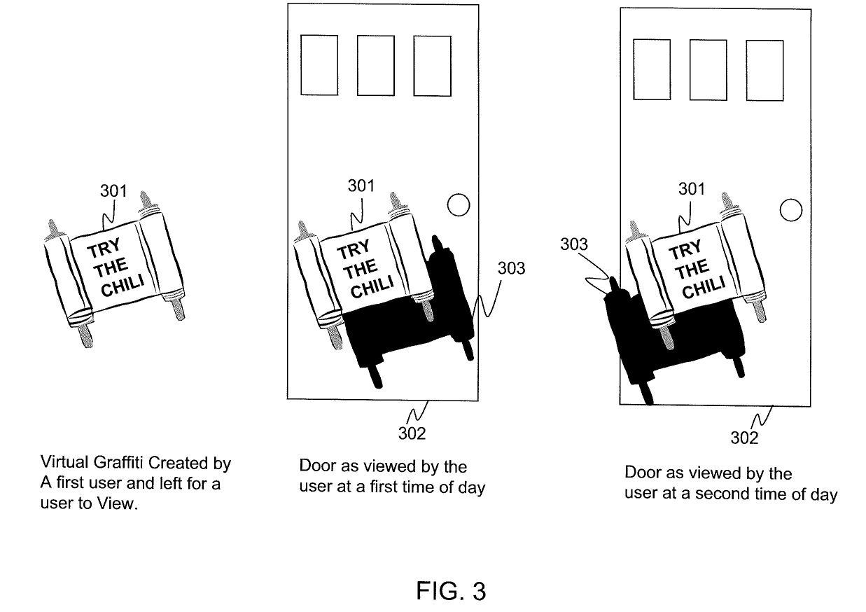

This is illustrated in FIG. 3. As shown in FIG. 3 a first user creates virtual graffiti 301. Virtual graffiti 301 comprises at least two parts; a first virtual object (scroll) along with virtual text (“try the chili”). Virtual graffiti 301 is attached to door 302 and left for a second user to view. As is evident, virtual graffiti 301 is displayed with a shadow 303 that changes with the time of day. For example, door 302 viewed at a first time of day will have shadow 303 displayed to the lower right of graffiti 301. However, door 302 viewed at a second time of day will have shadow 303 displayed to the lower left of graffiti 301.

It should be noted that the above example was given with respect to the virtual graffiti changing its shadow in response to ambient light, however, in alternate embodiments of the present invention virtual graffiti 301 may change any combination of shadow, brightness, contrast, color, specular highlights, or texture maps in response to the ambient light. Additionally, in one embodiment of the present invention, the virtual graffiti is modified in response to ambient light by the device 105-109 viewing the virtual graffiti, however in another embodiment, the virtual graffiti is modified by server 101 prior to being transmitted to devices 105-109.

As is evident, for any particular device 105-109 to be able to display virtual graffiti attached to a particular “real” object, the device must be capable of identifying the object's location, and then displaying the graffiti at the object's location. There are several methods for accomplishing this task. In one embodiment of the present invention, this is accomplished via the technique described in US2007/0024527, METHOD AND DEVICE FOR AUGMENTED REALITY MESSAGE HIDING AND REVEALING by the augmented reality system using vision recognition to attempt to match the originally created virtual graffiti to the user's current environment. For example, the virtual graffiti created by a user may be uploaded to server 101 along with an image of the graffiti's surroundings. The image of the graffiti's surroundings along with the graffiti can be downloaded to a user's augmented reality system, and when a user's surroundings match the image of the graffiti's surroundings, the graffiti will be appropriately displayed.

In another embodiment of the present invention the attachment of the virtual graffiti to a physical object is accomplished by assigning the physical coordinates of the physical object (assumed to be GPS, but could be some other system) to the virtual graffiti. The physical coordinates must be converted into virtual coordinates used by the 3D rendering system that will generate the augmented-reality scene (one such 3D rendering system is the Java Mobile 3D Graphics, or M3G, API specifically designed for use on mobile devices). The most expedient way to accomplish the coordinate conversion is to set the virtual x coordinate to the longitude, the virtual y coordinate to the latitude, and the virtual z coordinate to the altitude thus duplicating the physical world in the virtual world by placing the origin of the virtual coordinate system at the center of the earth so that the point (0,0,0) would correspond the point where the equator and the prime meridian cross, projected onto the center of the earth. This would also conveniently eliminate the need to perform computationally expensive transformations from physical coordinates to virtual coordinates each time a virtual graffiti message is processed.

As previously mentioned, the physical coordinate system is assumed to be GPS, but GPS may not always be available (e.g., inside buildings). In such cases, any other suitable location system can be substituted, such as, for example, a WiFi-based indoor location system. Such a system could provide a location offset (x₀,y₀,z₀) from a fixed reference point (xᵣ,yᵣ,zᵣ) whose GPS coordinates are known. Whatever coordinate system is chosen, the resultant coordinates will always be transformable into any other coordinate system.

After obtaining the virtual coordinates of the virtual graffiti, a viewpoint must be established for the 3D rendering system to be able to render the virtual scene. The viewpoint must also be specified in virtual coordinates and is completely dependent upon the physical position and orientation (i.e., viewing direction) of the device. If the viewpoint faces the virtual graffiti, the user will see the virtual graffiti from the viewpoint's perspective. If the user moves toward the virtual graffiti, the virtual graffiti will appear to increase in size. If the user turns 180 degrees in place to face away from the virtual graffiti, the virtual graffiti will no longer be visible and will not be displayed. All of these visual changes are automatically handled by the 3D rendering system based on the viewpoint.

Given a virtual scene containing virtual graffiti (at the specified virtual coordinates) and a viewpoint, the 3D rendering system can produce a view of the virtual scene unique to the user. This virtual scene must be overlaid onto a view of the real world to produce an augmented-reality scene. One method to overlay the virtual scene onto a view of the real world from the mobile device's camera is to make use of an M3G background object which allows any image to be placed behind the virtual scene as its background. Using the M3G background, continuously updated frames from the camera can be placed behind the virtual scene, thus making the scene appear to be overlaid on the camera output.

Given the above information, a device's location is determined and sent to the server. The server determines what messages, if any, are in proximity to and available for the device. These messages are then downloaded by the device and processed. The processing involves transforming the physical locations of the virtual messages into virtual coordinates. The messages are then placed at those virtual coordinates. At the same time, the device's position and its orientation are used to define a viewpoint into the virtual world also in virtual coordinates. If the downloaded virtual message is visible from the given viewpoint, it is rendered on a mobile device's display on top of live video of the scene from the device's camera.

Thus, if the user wants to place a virtual message on the top of an object, the user must identify the location of the point on top of the object where the message will be left. In the simplest case, the user can place his device on the object and capture the location. He then sends this location with the virtual object and its associated content (e.g., a beer stein with the text message “try the porter” applied to the southward-facing side of the stein) to the server. The user further specifies that the message be available for a particular user. When the particular user arrives at the bar and is within range of the message, they will see the message from their location (and, therefore, their viewpoint). If they are looking toward the eastward-facing side of the message, they will see the stein, but will just be able to tell that there is some text message on the southern side. If a user wishes to read the text message, they will have to move their device (and thus their viewpoint) so that it is facing the southern side of the stein.

FIG. 4 is a block diagram of a server of FIG. 1. As is evident, server 101 comprises a global object manager 401, database 403, personal object manager 405, and optional ambient light modification circuitry 411. During operation, global object manager 401 will receive virtual graffiti from any device 105-109 wishing to store graffiti on server 101. This information is preferably received wirelessly through receiver 407. Global object manager 401 is responsible for storing all virtual graffiti existing within system 100. Along with the virtual graffiti, global object manager 401 will also receive a location for the graffiti along with a list of devices that are allowed to display the graffiti. Again, this information is preferably received wirelessly through receiver 407. If the graffiti is to be attached to a particular item (moving or stationary), then the information needed for attaching the virtual graffiti to the object will be received as well. For the first embodiment, a digital representation of a stationary item's surroundings will be stored; for the second embodiment, the physical location of moving or stationary virtual graffiti will be stored. All of the above information is stored in database 403.

Although only one personal object manager 405 is shown in FIG. 4, it is envisioned that each user device will have its own personal object manager 405. Personal object manager 405 is intended to serve as an intermediary between its corresponding user device and global object manager 401. Personal object manager 405 will periodically receive a location for its corresponding user device. Once personal object manager 405 has determined the location of the device, personal object manager 405 will access global object manager 401 to determine if any virtual graffiti exists for the particular device at, or near the device's location. Personal object manager 405 filters all available virtual graffiti in order to determine only the virtual graffiti relevant to the particular device and the device's location. Personal object manager 405 then provides the device with the relevant information needed to display the virtual graffiti based on the location of the device, wherein the relevant virtual graffiti changes based on the identity and location of the device. This information will be provided to the device by instructing transmitter 409 to transmit the information wirelessly to the device. It should be noted that if server 101 is to modify the graffiti based on ambient light, circuitry 411 will modify the graffiti before being transmitted.

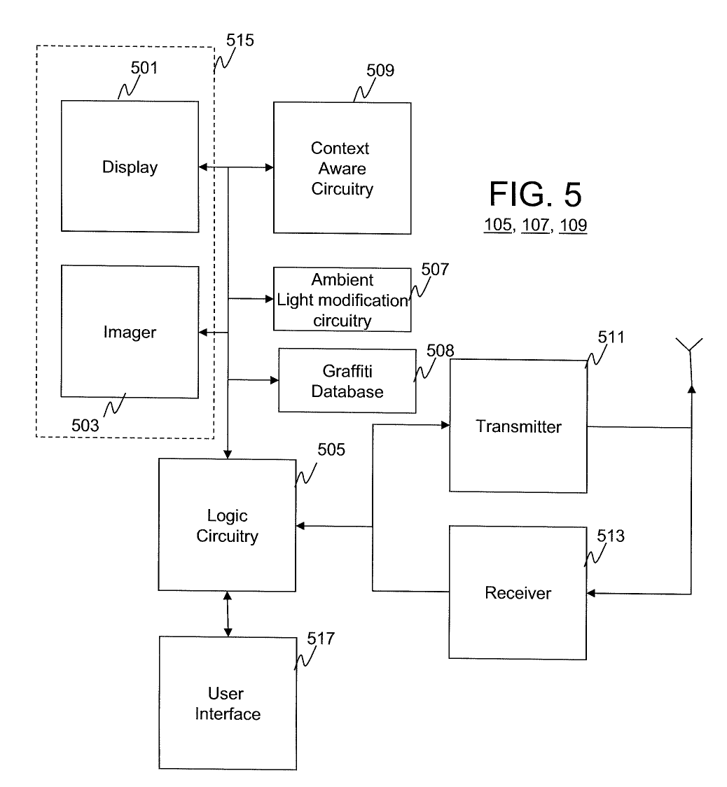

FIG. 5 is a block diagram of a user device of FIG. 1. As shown, the user device comprises augmented reality system 515, context-aware circuitry 509, ambient light modification circuitry 507, graffiti database 508, logic circuitry 505, transmitter 511, receiver 513, and user interface 517. Context-aware circuitry 509 may comprise any device capable of generating a current context for the user device. For example, context-aware circuitry 509 may comprise a GPS receiver capable of determining a location of the user device. Alternatively, circuitry 509 may comprise such things as a clock, a thermometer capable of determining an ambient temperature, an internet connection capable of determining the current weather, a sun position calculator, a light detector, a biometric monitor such as a heart-rate monitor, an accelerometer, a barometer, a connection to an application that determines if the user is indoors or outdoors, etc.

During operation, a user of the device creates virtual graffiti via user interface 517. The virtual graffiti preferably, but not necessarily, comprises at least two parts, a virtual object and content. The virtual object is a 3D object model that can be a primitive polygon or a complex polyhedron representing an avatar, for example. The content is preferably either text, pre-stored images such as clip art, pictures, photos, audio or video clips, . . . , etc. The virtual object and its associated content comprise virtual graffiti that is stored in graffiti database 508. In one embodiment of the present invention, user interface 517 comprises an electronic tablet capable of obtaining virtual objects from graffiti database 508 and creating handwritten messages and/or pictures.

Once logic circuitry 505 receives the virtual graffiti from user interface 517 or graffiti database 508, logic circuitry 505 accesses context-aware circuitry 509 and determines a location where the graffiti was created (for stationary graffiti) or the device to which the virtual graffiti will be attached (for mobile graffiti). Logic circuitry 505 also receives a list of users with privileges to view the graffiti. This list is also provided to logic circuitry 505 through user interface 517.

In one embodiment of the present invention the virtual graffiti is associated with a physical object. When this is the case, logic circuitry 505 will also receive information required to attach the graffiti to an object. Finally, the virtual graffiti is provided to virtual graffiti server 101 by logic circuitry 505 instructing transmitter 511 to transmit the virtual graffiti, the location, the list of users able to view the graffiti, and if relevant, the information needed to attach the graffiti to an object. As discussed above, server 101 periodically monitors the locations of all devices 105-109 along with their identities, and when a particular device is near a location where it is to be provided with virtual graffiti, server 101 utilizes network 103 to provide this information to the device.

When a particular device is near a location where virtual graffiti is available for viewing, the device will notify the user, for example, by instructing user interface 517 to beep. The user can then use the device to view the virtual graffiti as part of an augmented-reality scene. Thus, when the device of FIG. 5 is near a location where virtual graffiti is available for it, receiver 513 will receive the graffiti and the location of the graffiti from server 101. If relevant, receiver 513 will also receive information needed to attach the graffiti to a physical object. This information will be passed to logic circuitry 505.

Receiver 513 will receive virtual graffiti and its location. Logic circuitry 505 will store this graffiti within graffiti database 508. Logic circuitry 505 periodically accesses context-aware circuitry 509 to get updates to its location and provides these updates to server 101. When logic circuitry 505 determines that the virtual graffiti should be displayed, it will access ambient light modification circuitry 507, causing circuitry 507 to update the virtual graffiti based on the ambient light. The user can then use augmented reality system 515 to display the updated graffiti. More particularly, imager 503 will image the current background and provide this to display 501. Display 501 will also receive the virtual graffiti from graffiti database 508 and provide an image of the current background with the graffiti appropriately displayed. Thus, the virtual graffiti will be embedded in or merged with the user's view of the real-world.

### Modification of Virtual Graffiti Based on Ambient Light

As discussed above, to further enhance the user experience, the virtual graffiti can be dynamic, changing based on the ambient light. When modification to the virtual graffiti is to take place via a user device, each user device will comprise ambient light modification circuitry 507 to perform this task. However, when modification to the virtual graffiti is to take place via server 101, server 101 will modify the graffiti via ambient light modification circuitry 411 prior to sending the virtual graffiti to the user device. Regardless of where the virtual graffiti gets modified based on the ambient light; circuitry will perform the following steps in order to make the modification.
Optionally determining if the device is indoors or outdoors. This determination can be made in several ways. In one embodiment of the present invention this determination can be made by accessing context-aware circuitry 509 and determining GPS coordinates for the device. From the GPS coordinates a point-of-interest database (not shown in FIG. 5) may be accessed to determine if the user/graffiti is indoors or outdoors. In a second embodiment, context-aware circuitry comprises a light sensor, and based on an amount of ambient light hitting sensor 509, circuitry 507 will make a determination if the device is indoors or not, or if there is heavy cloud cover.
Accessing context-aware circuitry to determine position data for the sun. This data preferably comprises an apparent geocentric position such as a right ascension and declination for the sun.
Determine position data for the virtual graffiti. This data preferably comprises Global Positioning System (GPS) data, i.e., latitude, longitude, and altitude measurements.
Modifying the virtual graffiti based on the position data for the virtual graffiti and the position data for the sun. As discussed above, the step of modifying the virtual graffiti will comprise casting a virtual shadow for the virtual graffiti, however, in alternate embodiments of the present invention the modification may comprise modifying any combination of shadow, brightness, contrast, color, specular highlights, or texture maps in response to the ambient light. It should be noted that if it is determined that the device is indoors, or that there is heavy cloud cover, or that the sun is over the horizon, possibly no modification to the graffiti will take place.

In alternate embodiments of the present invention, further modification of the virtual graffiti may take place by modifying the virtual graffiti based on current weather conditions, and in particular, amount of cloud cover. More particularly, circuitry 507 may access context-aware circuitry 509 to determine a current weather report (e.g., % cloud cover) for the local area. The virtual graffiti may then be further modified by reducing the intensity of the virtual light sources according to attenuation factors associated with the level of cloud cover.

In yet another alternate embodiment of the present invention, further modification of the virtual graffiti may take place by modifying the virtual graffiti based on current ambient light as determined from a light sensor. More particularly, circuitry 507 may access context-aware circuitry 509 to determine an amount of ambient light. (In this particular embodiment context-aware circuitry 509 comprises a light sensor). The virtual graffiti may then be further modified by adjusting the intensity of virtual light sources to match the measured values detected by the light sensor.

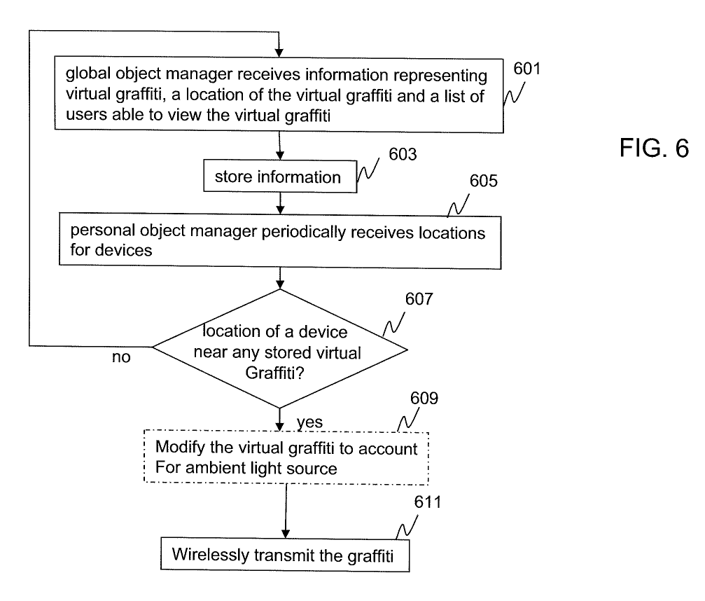

FIG. 6 is a flow chart showing operation of the server of FIG. 1. The logic flow begins at step 601 where global object manager 401 receives from a first device, information representing virtual graffiti, a location of the virtual graffiti, and a list of users able to view the virtual graffiti. It should be noted that the information received at step 601 may be updates to existing information. For example, when the virtual graffiti is “mobile”, global object manager 401 may receive periodic updates to the location of the graffiti. Also, when the virtual graffiti is changing (e.g., a heart rate) global object manager 401 may receive periodic updates to the graffiti.

Continuing with the logic flow of FIG. 6, information is then stored in database 403 (step 603). As discussed above, personal object manager 405 will periodically receive locations (e.g., geographical regions) for all devices, including the first device (step 605) and determine if the location of a device is near any stored virtual graffiti (step 607). If, at step 607, personal object manager 405 determines that its corresponding device (second device) is near any virtual graffiti (which may be attached to the first device) that it is able to view, then the logic flow optionally continues to step 609 (if ambient light modification is taking place in server 101). At step 609 the virtual graffiti is modified by modification circuitry 411 to account for ambient light. The logic flow then continues to step 611 where the graffiti and the necessary information for viewing the virtual graffiti (e.g., the location of the graffiti) is wirelessly transmitted to the second device via transmitter 409.

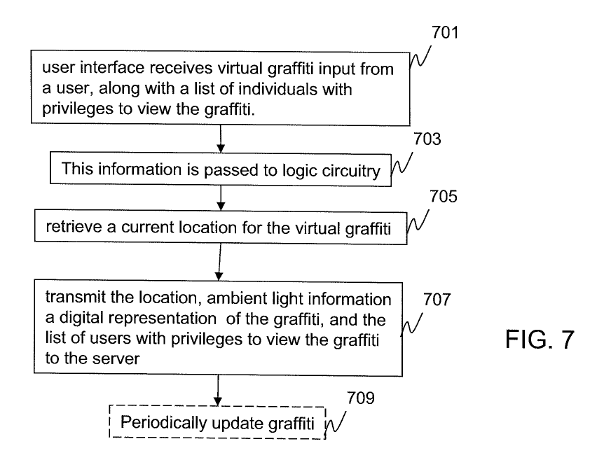

FIG. 7 is a flow chart showing operation of the user device of FIG. 1 when creating graffiti. In particular, the logic flow of FIG. 7 shows the steps necessary to create virtual graffiti and store the graffiti on server 101 for others to view. The logic flow begins at step 701 where user interface 517 receives virtual graffiti input from a user, along with a list of devices or individuals with privileges to view the graffiti. The virtual graffiti in this case may be input from a user via user interface 517, or may be graffiti taken from context-aware circuitry 509. For example, when context aware circuitry comprises a heart-rate monitor, the graffiti may be the actual heart rate taken from circuitry 509.

This information is passed to logic circuitry 505 (step 703). At step 705, logic circuitry 505 accesses context-aware circuitry 509 and retrieves a current location for the virtual graffiti. The logic flow continues to step 707 where logic circuitry 505 instructs transmitter 511 to transmit the location, a digital representation (e.g., a .jpeg or .gif image) of the graffiti, and the list of users with privileges to view the graffiti. It should be noted that in the 3D virtual object case, the digital representation could include URLs to 3D models and content (e.g., photos, music files, etc.). Additionally, if ambient-light modification of the graffiti takes place at server 101, ambient-light information may be transmitted to server 101. For example, if context-aware circuitry comprises a light sensor, an amount of ambient light may be sent to server 101 in order to aide in modifying the virtual graffiti.

Finally, if the virtual graffiti is changing in appearance, the logic flow may continue to optional step 709 where logic circuitry 505 periodically updates the graffiti. For example, if an ambient light sensor detects a change in ambient light (e.g., sudden cloud cover, sudden sunshine, . . . , etc) this information may be transmitted to server 101 to aide in graffiti modification.

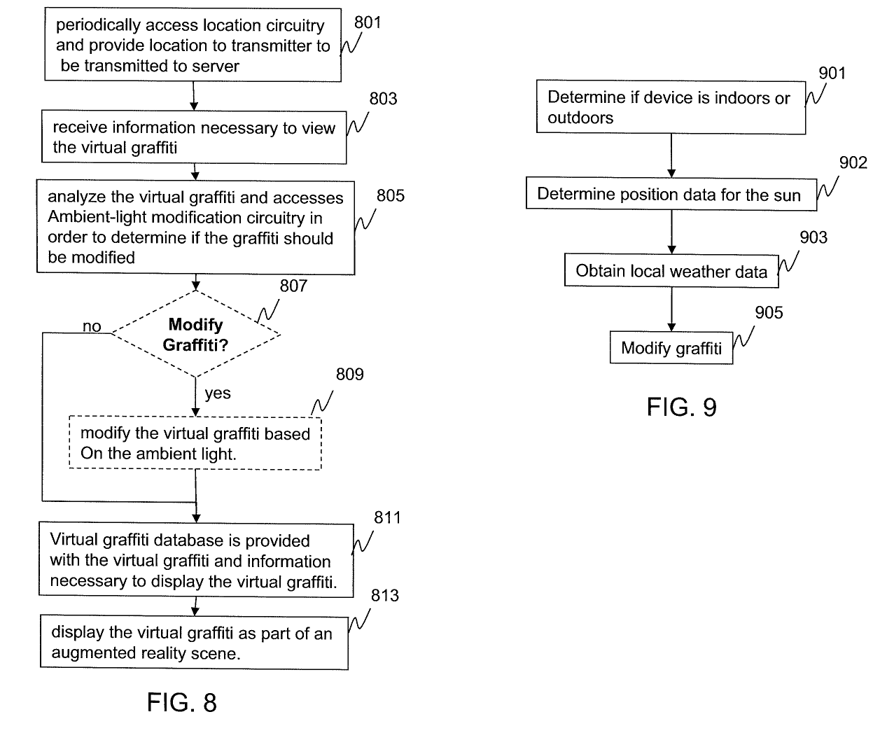

FIG. 8 is a flow chart showing operation of the user device of FIG. 1. In particular, the logic flow of FIG. 8 shows those steps necessary to display virtual graffiti. The logic flow begins at step 801 where logic circuitry 505 periodically accesses context-aware circuitry 509 and provides a location to transmitter 511 to be transmitted to server 101. In response to the step of providing the location, at step 803, receiver 513 receives information necessary to view virtual graffiti. As discussed above, this information may simply contain a gross location of the virtual graffiti along with a representation of the virtual graffiti. In other embodiments, this information may contain the necessary information to attach the virtual graffiti to an object. Such information may include a digital representation of the physical object, or a precise location of the virtual graffiti.

At step 805, logic circuitry 505 (acting as a profile manager) analyzes the virtual graffiti and ambient-light modification circuitry 507 to determine if the graffiti should be modified to be better viewed in the current light. This determination is made either by a user-specified condition, on a threshold, or always. If a user disables this feature, no modifications will be made. If modifications are to be based on thresholds, the virtual graffiti will be modified when the ambient light exceeds an upper threshold or falls below a lower threshold. In the former case, the virtual graffiti will need to be illuminated to match the increased ambient light; in the latter the illumination on the graffiti will need to be reduced to match the ambient light. The last alternative is to always modify the graffiti based on the current lighting conditions

Continuing, at step 807, logic circuitry 505 determines if the graffiti should be modified, and if not the logic flow continues to step 811, otherwise the logic flow continues to step 809 where ambient-light modification circuitry 507 appropriately modifies the virtual graffiti based on the ambient light. At step 811, logic circuitry 505 accesses virtual graffiti database 508 and stores the modified or unmodified virtual graffiti along with other information necessary to display the graffiti (e.g., the location of the graffiti). Finally, at step 813, display 501 (as part of augmented reality system 515) displays the modified or unmodified virtual graffiti as part of an augmented-reality scene when the user is at the appropriate location.

FIG. 9 is a flow chart showing operation of ambient light modification circuitry. As discussed, the ambient light modification circuitry may be located locally in each user device, or may be centrally located within server 101. Regardless of where the circuitry is located, some or all of the following steps are taken when modification of virtual graffiti is performed:

At steps 901-903 ambient-light information is obtained. More particularly, at step 901 a determination is made as to whether or not the device is indoors or outdoors. As discussed above, this determination can be made in several ways. In one embodiment of the present invention this determination can be made by accessing context-aware circuitry 509 and determining GPS coordinates for the device. From the GPS coordinates a point-of-interest database may be accessed to determine if the user/graffiti is indoors or outdoors. In a second embodiment, context-aware circuitry comprises a light sensor, and based on an amount of detected ambient light hitting sensor 509, circuitry 507 will make a determination if the device is indoors or not, or there is heavy cloud cover.

At step 902 context-aware circuitry 509 is accessed to determine position data for the sun. This is accomplished by determining a local time and date, and calculating the position for the sun based on the local time and date. This data preferably comprises an apparent geocentric position such as a right ascension and declination for the sun.

At step 903 local weather data (e.g., an amount of cloud cover) is obtained. This information may be obtained from context-aware circuitry 509, with context-aware circuitry 509 acting as a data path to a local-weather database. For example context-aware circuitry 509 may comprise an internet access that accesses local weather via one of many available internet weather sites.

Once ambient-light information is obtained (from steps 901-903), the logic flow continues to step 905 where the virtual graffiti is modified based on the sun position data and optionally the amount of ambient light. As discussed above, the step of modifying the virtual graffiti will comprise casting a virtual shadow for the virtual graffiti if it determined that the sun is shining, however, in alternate embodiments of the present invention the modification may comprise modifying any combination of shadow, brightness, contrast, color, specular highlights, or texture maps in response to the ambient light. Some of the possible modifications to the graffiti are:
casting a virtual shadow for the graffiti when it is determined that the sun is shining. The determination that the sun is shining may be made via local-weather data, an ambient light source, and/or whether or not the device is indoors or outdoors. The intensity of virtual shadow can also be adjusted based on the ambient light.
brightening the virtual graffiti if an ambient-light sensor determines that the device is in a dark place.
adjusting the color of the virtual graffiti to increase or decrease its visibility based on the ambient light
changing a texture map to alter the appearance of the virtual graffiti based on the ambient light
adding a specular highlight at a particular location on the virtual graffiti based on the relative position of the sun to the virtual graffiti

While the invention has been particularly shown and described with reference to particular embodiments, it will be understood by those skilled in the art that various changes in form and details may be made therein without departing from the spirit and scope of the invention. It is intended that such changes come within the scope of the following claims.

1. A method for modifying a virtual graffiti object, the method comprising the steps of:
obtaining sun location data;
obtaining virtual graffiti; and
modifying the virtual graffiti based on the sun location data.

2. The method of claim 1 further comprising the step of:
transmitting the modified virtual graffiti to a device to be displayed as an augmented-reality scene.

3. The method of claim 1 further comprising the step of:
displaying the modified virtual graffiti as part of an augmented-reality scene.

4. The method of claim 1 wherein the step of obtaining sun location data comprises the step of obtaining a right ascension and declination for the sun.

5. The method of claim 1 wherein the step of modifying the virtual graffiti comprises the step of modifying any combination of shadow, brightness, contrast, color, specular highlights, or texture maps in response to the ambient light.

6. The method of claim 1 further comprising the steps of:
obtaining local weather data;
further modifying the virtual graffiti based on the weather data.

7. The method of claim 6 wherein the step of local weather data comprises the step of obtaining an amount of cloud cover.

8. The method of claim 6 wherein the step of modifying the virtual graffiti comprises the step of modifying any combination of shadow, brightness, contrast, color, specular highlights, or texture maps in response to the ambient light.

9. The method of claim 6 further comprising the step of:
transmitting the modified virtual graffiti to a device to be displayed as an augmented-reality scene.

10. The method of claim 6 further comprising the step of:
displaying the modified virtual graffiti as part of an augmented-reality scene.

11. The method of claim 1 wherein the virtual graffiti comprises an object to view as part of an augmented-reality scene.

12. A method for receiving and displaying virtual graffiti as part of an augmented-reality scene, the method comprising the steps of:
providing a location;
receiving virtual graffiti in response to the step of providing the location;
obtaining ambient-light information;
modifying the virtual graffiti based on the ambient-light information; and
displaying the modified virtual graffiti as part of an augmented-reality scene.

13. The method of claim 12 wherein the ambient-light information comprises a position of the sun, an amount of cloud cover, an amount of detected ambient light, and/or whether or not a device is indoors or outdoors.

14. The method of claim 12 wherein the step of modifying the virtual graffiti comprises the step of modifying any combination of shadow, brightness, contrast, color, specular highlights, or texture maps in response to the ambient light.

15. An apparatus for receiving and displaying virtual graffiti as part of an augmented-reality scene, the apparatus comprising:
a transmitter providing a location;
a receiver receiving virtual graffiti in response to the step of providing the location;
circuitry determining ambient-light information and modifying the virtual graffiti based on the ambient-light information; and
an augmented reality system displaying the modified virtual graffiti as part of an augmented-reality scene.

16. The apparatus of claim 15 wherein the ambient-light information comprises a position of the sun, an amount of cloud cover, an amount of detected ambient light, and/or whether or not a device is indoors or outdoors.

17. The apparatus of claim 15 wherein the virtual graffiti is modified by modifying any combination of shadow, brightness, contrast, color, specular highlights, or texture maps in response to the ambient light.
